(19) United States
(12) Patent Application Publication
(10) Pub. No.: US 2009/0226681 A1
(43) Pub. Date: Sep. 10, 2009

(54) Pigment printing process and related fabrics

(76) Inventor: Kenneth Kuk-Kei Wang, Sai Kung (HK)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/074,646

(22) Filed: Mar. 5, 2008

(51) Int. Cl. B32B 3/00; B05D 5/00; B41M 1/12

(52) U.S. Cl. 428/196; 427/288; 101/129

(57) ABSTRACT

A method for pigment printing onto a fabric is provided wherein the method comprises preparing a color pigment paste. The paste includes pigments of a desired color having a size no larger than about 1 micron in diameter, a binder and a thickening agent. The method further includes printing the prepared color pigment paste onto the fabric and heating the printed fabric to a temperature of at least 150° C. The printed fabric is then washed at least once to remove the thickening agent and to incorporate a softening agent into the fabric, thereby providing the fabric with a softer hand feel than the fabric had before the washing; and finishing setting the fabric.

### FIELD OF THE INVENTION

The present invention relates to a pigment printing process for printing on a textile fabric such as a cloth or other woven or non-woven fabric, and, more particularly, to a printing process that provides for a fabric that will still have a soft hand feel after printing. Specifically, the present invention relates to a method for printing on textile fabrics that uses improved pigment colorants in the printing step of the process to provide a special water soluble paste that, with the addition of a washing process, dissolves away the harsh hand feel, leaving the printed fabric soft.

### BACKGROUND OF THE INVENTION

Textile fabrics are used in a variety of industries, including the garment industry. It is highly desirable and often required that such textile fabrics, when made into garments or apparel, provide a soft and comfortable feeling to wearers. Oftentimes, however, the softness and “comfortable feel” of the garment is diminished significantly when the garment has been subjected to a pigment printing process.

Printing is a process wherein the coloring or treating material, usually in the form of a paste, is deposited onto the surface of the fabric which is then typically further treated with steam, heat or chemicals for fixation of the coloring or treating material onto the fabric. A printing process is to be differentiated from a dyeing process. A dyeing process incorporates or embeds the coloring or treating material into the fibers or yarns of the fabric through a chemical reaction between the chromophores of the dyestuffs and the substrate to be dyed. In contrast, a printing process, and particularly, a pigment printing process, does not involve a chemical reaction between the pigments and the substrate (e.g., yarns). Instead, the printing process simply affixes the coloring or treating material, namely pigments, to the surface of the yarns or fabric with the addition of a binder. Binders can be considered as adhesives.

Like dyeing, there are a number of different printing methods. However, a common method for printing on garments and like textile fabric articles is pigment printing. As the name suggests, pigment printing requires the use of pigments (not dyes) as the coloring or treating material. Notably, pigments colorants are insoluble whereas dyestuffs are soluble. It will be appreciated that such pigments do not penetrate the fiber of the fabric but instead are affixed to the surface of the fabric by means of synthetic resins or binders which are cured after application to make them insoluble.

While pigment printing on fabrics may be performed in a number of ways, one of the most common pigment printing methods for printing on textile fabrics and like articles is through a process known as silk screening. In silk screening, the color pigment is applied to the surface of the fabric as a paste by pressing the paste through screens. Such screens were originally made of silk, but are not always made from silk these days. This method of pigment printing is very cost effective and highly efficient as a printing process for textile fabrics such as garments and apparel.

Disadvantageously, fabrics that have, heretofore, been pigment printed by silk screening or other known printing methods generally have a harsh and stiff hand feel. That is, the silk screened image printed on the garment is clearly more stiff where the image has been printed than at another part of the garment itself that was not subject to the pigment printing process. It is believed that the harsh and stiff feel of the pigment printed fabrics is caused by the large particle size of the binder paste and pigments used in the pigment printing process. Numerous efforts have been made in the industry to attempt to improve the softness of pigment printed fabrics but all, to date, have been generally unsuccessful.

With no known solutions to the problem of harsh hand feel for pigment printed fabrics to date, some garment manufacturers have sought to use an alternative, more expensive, and more difficult to process printing method. One alternative process is known as reactive printing. While reactive printed fabrics are known to have soft hand feels, they also come with numerous other disadvantages. For instance, reactive printing is a much more complicated and expensive printing process. It requires additional washing and steaming steps not required of most pigment printing processes. It is also difficult to control color accuracy in the reactive printing process due to the need for additional process steps in the production of the printed fabrics. The reactive printing process is also limited in that it can only be used for printing on 100% cotton fabrics, and it does not achieve very bright or luminescent colors. And finally, reactive printed fabrics cannot withstand bleaching.

Another alternative process is known as discharge printing. Discharge printing involves discharging (or removing) the dye in a textile substrate and screen printing a coloring or treating material onto the resulting natural (pre-dyed) color of the fabric. Options include laying down a discharge underbase and overprinting with conventional water-based or plastisol inks or printing with a formula that discharges the garment dye first and then puts down the color. Like reactive printing however, there are several disadvantages to this process, including the fact that discharge printing is a much more complicated and expensive printing process. Like reactive printing, it also is difficult to control color accuracy in discharge printing. Still further, discharge printing only works for a limited number and types of colors and only with certain dyes on natural (e.g., 100% cotton) fabrics.

Thus, the need exists for a method of pigment printing on garments and other textile fabrics that will, at worst, not diminish significantly, and, at best, enhance the softness and “comfortable feel” of the garments or textile fabrics. A pigment printing process that can provide a printed fabric with a soft hand feel at least comparable to the soft hand feel of reactive printed fabrics, but without all of the disadvantages of those reactive printed fabrics, is believed to be highly desirable.

### SUMMARY OF THE INVENTION

Any one or more of the foregoing aspects of the present invention, together with the advantages thereof over the known art relating to pigment printing processes and pigment printed fabrics, which shall become apparent from the specification and drawings that follows, may be accomplished by the invention as hereinafter described and claimed.

The present invention provides a method for pigment printing onto a fabric, the method comprising: preparing a color pigment paste, the paste including pigments of a desired color having a majority of pigment particles of a size no larger than about 1 micron in diameter, a binder and a thickening agent; printing the prepared color pigment paste onto the fabric; heating the printed fabric to a temperature of at least 150° C.; washing the fabric at least once to remove the thickening agent and to incorporate a softening agent into the fabric, thereby providing the fabric with a softer hand feel than the fabric had before the washing; and finishing setting the fabric.

In accordance with another embodiment, the present invention provides a fabric having a print that has been pigment printed onto the fabric using a color pigment paste including pigment particles of a desired color, a binder and a thickening agent, wherein the majority of said pigment particles have a size that is no larger than about 1 micron in diameter, and wherein the fabric that has been printed upon has a hand feel that is softer, smoother and less stiff than a hand feel of a comparable fabric having a print that has been pigment printed upon using a color pigment paste including pigment particles, but wherein a majority of the pigment particles of the color pigment paste used for the print on the comparable fabric are larger than about 1 micron in diameter.

In accordance with another embodiment, the present invention provides a pigment printed fabric having a soft hand feel comparable to a reactive printed fabric.

### DETAILED DESCRIPTION OF THE PREFERRED EMBODIMENTS

As stated above, the present invention is directed toward a method of pigment printing onto textile fabrics such as garments wherein the printed fabric will have a soft hand feel. Hand, or hand feel, refers to the tactile qualities or characteristics of a fabric perceived by touch, such as softness, stiffness, and smoothness. By comparing certain measurable physical properties, such as surface contour and friction, firmness, rigidity, elasticity, shear, fineness, resilience, bending, tensile, compression, thickness and other characteristics, one can determine and compare whether one fabric has a softer hand feel over another fabric. That is, a fabric having soft hand feel may be characterized as being highly elastic, relatively smooth and soft, as opposed to a fabric having a harsh hand feel, wherein the fabric is notably more stiff and rough.

The Kawabata Evaluation System (KES-FB system) is one method that has been developed to measure hand feel. This testing method can be performed in various laboratories without undue burden. The KES-FB system requires a set of instruments with which to measure various fabric properties and then correlates those measurements with the subjective assessment of hand feel. The aim is to provide an objective test that enables reproducibility of the measurement of total hand value of a fabric. In order to do so, first, fabric specimens undergo testing of tensile, shear, bending, compression surface friction, and surface variation (roughness). Various instruments known in the art measure these properties. In the KES-FB system, a total of sixteen (16) parameters are measured, all at low levels of force, which are intended to mimic the actual fabric deformations found in use. The properties measured include:

| | | |
|---|---|---|
| Tensile | LT | Linearity of load extension curve |
| | WT | Tensile energy |
| | RT | Tensile resilience |
| Shear | G | Shear rigidity |
| | 2HG | Hystersis of shear force at 0.5° |
| | 2HG5 | Hystersis of shear force at 5° |
| Bending | B | Bending rigidity |
| | 2HB | Hystersis of bending moment |
| Lateral compression | LC | Linearity of compression thickness |
| | | curve |
| | WC | Compressional energy |
| | RC | Compressional resilience |
| Surface characteristics | MIU | Coefficient of friction |
| | MMD | Mean deviation of MIU |
| | SMD | Geometrical roughness |
| Fabric construction | W | Fabric weight per unit area |
| | To | Fabric thickness |

All of these measurements are then converted into Primary Hand Values by a set of translation equations known to the skilled artisan having experience with the KES-FB system, and Total Hand Values are then calculated from these Primary Hand Values by the use of a second translation equation, also well known to those familiar with the KES-FB system.

In an alternative embodiment and at the very least, the hand feel of the pigment printed fabrics of the present invention may be compared to hand feel of the reactive printed fabrics of the prior art. The present invention is believed to provide a soft hand feel that is at least as soft as the hand feel of the reactive printed fabrics of the present invention. Again, although it is believed that soft hand feel can often be determined by the perception of touch, measurement of physical properties of the fabrics can be made to determine the softness, smoothness or stiffness of the fabric where printing has occurred so as to provide evidence of comparable soft hand feel between reactive printed fabrics and the pigment printed fabrics of the present invention.

Unlike reactive printed fabrics however, in the production of pigment printed fabrics, essentially any known textile fabric may be used. Textile fabrics may include those fabric made from staple fibers and filaments suitable for conversion to or use as yarns, and may be made into woven or knitted fabrics; those fabrics made from yarns made from natural or man-made fibers or combinations of both; and those fabrics suitable for manufacturing or fabrication into garments and other articles wherein the garments or other articles retain the characteristic flexibility and drape of the original fabrics. In one embodiment, the textile fabrics may be a cellulose-based fabric. Such cellulosic fabrics include cotton, linen, rayon, ramie and the like. In at least another embodiment, the fabrics are constructed by weaving fibers using manufacturing processes known in the art. In at least another embodiment, the fabrics are constructed by weaving yarns, again using manufacturing processes known in the art. In one embodiment, the fabrics of the present invention are made from cotton fibers or yarns, woven into garments. In another embodiment, the fabrics of the present invention are made from cotton fibers or yarns knitted into garments.

In the printing process, the fabrics are first subjected to printing using essentially any fabric screening techniques known in the art. One common technique is silk screening where the color pigment is applied to the surface of the fabric as a paste by pressing the paste through screens. The screens are conventionally made of silk, but any screen suitable for silk screen printing can be utilized. Essentially any printing process that uses the defined homogenous printing pastes with ultra fine color pigment dyestuffs described below can be used for the present invention. Because the printing process of the present invention incorporates the use of pigment colorants in the printing process, the printing process is known in the art as a pigment printing process.

The color pigment printing paste used in the present invention therefore includes at least pigment colorants. Pigment colorants differ from dyes in that they originate as solid particles, not liquid solutions. In other words, dyes are typically completely soluble in water whereas pigmented colorants are not. Pigment colorants tend to settle onto the fibers or yarns of the fabric and are bound to the fabric by binding agents whereas dyes are chemically bound into the fibers or yarns of the fabrics. Pigment colorants tend to be more water resistant than dyes as well.

The pigment colorants of the present invention may be any known pigment colorants known in the art that will provide the color desired to the fabric during printing, including the colors yellow, green and blue. Examples of such pigment colorants include, but are not limited to, arsenic pigments (Paris green); carbon pigments (carbon black, ivory black, vine black lamp black); cadmium pigments (cadmium green, cadmium red, cadmium yellow, cadmium orange); iron oxide pigments (caput mortuum, oxide red, red ochre, sanguine, Venetian red, mars black; Prussian blue pigments; chromium pigments (chrome green, chrome yellow); cobalt pigments (cobalt blue, cerulean blue, cobalt violet, aureolin); lead pigments (lead white, Naples yellow, cremnitz white, red lead); copper pigments (Paris green, verdigris, viridian, Egyptian blue, han purple); titanium pigments (titanium white, titanium beige, titanium yellow, titanium black); ultramarine pigments (ultramarine, ultramarine green shade, French ultramarine); mercury pigments (vermilion); zinc pigments (zinc white); clay earth (iron oxide) pigments (raw sienna, burnt sienna, raw umber, burnt yellow, yellow ochre); organic pigments (pigment red 170, phthalo green, phthalo blue, quinacridone magenta); and lapis lazuli. Pigment colorants can be divided into inorganic compounds and organic compounds. In one embodiment, the pigments may be selected from inorganic compounds. In another embodiment, the pigments may be selected from organic compounds. In another embodiment, the pigments may be selected from iron oxide pigments. In another embodiment, the pigments may be selected from carbon pigments. In another embodiment, the pigments may be selected from chromium pigments. In another embodiment, the pigments may be selected from copper pigments. In another embodiment, the pigments may be selected from organic pigments.

More particularly, the present invention utilizes ultra fine pigment dyestuffs. Such dyestuffs are solid particles that have been grinded to a size no larger than about 1 micron in diameter. The grinding is performed by “nano grinders” having the ability to grind the pigments to such sizes as mentioned. In at least one embodiment, the majority of the pigment dyestuffs or particles are no larger than about 1 micron. In another embodiment, substantially all of the pigment particles are no larger than about 1 micron in diameter. In still another embodiment, most of the pigment particles can be grinded to a size of less than 1 micron. In yet a further embodiment, most of the pigment particles can be grinded to a size of between about 100 nanometers and about 0.5 microns. In another embodiment, most of the pigment dyestuffs are grinded to a size of between about 100 nanometers and about 400 nanometers. Such ultra fine pigment dyestuffs, when formed into a printing paste and printed onto a fabric, allow for the maximum penetration of the color into the fibers of the fabric, while maintain soft and bulky hand feel.

Once the pigment dyestuffs are grinded to a desired particle size of no larger than about 1 micron, the grinded pigment dyestuffs may then be blended with one or more binders, thickeners or other ingredients. In one embodiment, the ingredients, including the pigment dyestuffs and the other ingredients, such as, for example, the thickeners, binders, and optionally cross-linkers, are mixed through high speed stirring into a highly homogenous emulsion that can penetrate the fabric to become fully attached onto the surfaces of the fibers and yarns of the fabrics to be printed during the screen printing. The emulsion is prepared to essentially a solution that contains no “feelable” non-soluble particles so that the hand feel of the printed fabrics will be very soft and smooth. The ability of the printing paste to become almost a solution in having no “feelable” particles is an important aspect of the present invention in allowing the printed fabrics to maintain a soft hand feel.

With respect to the binders, essentially any binders known to be blendable with the pigment colorants of the present invention and soluble in aqueous solution as set forth herein may be used in the present invention. However, it will be appreciated that certain binders that provide normal printing pastes often cause the fabric to have a very coarse and harsh hand feel upon printing. Therefore, in at least one embodiment of the present invention, a very small amount of a very soft binder is used with the ultra fine-sized pigment dyestuffs to provide a water soluble paste that not only aids in the soft hand feel of the fabric but also provides color fastness for the fabric. In one embodiment, the binder is employed in amounts ranging from about 1 to about 50 weight percent, based upon the total composition of the printing paste. In another embodiment, the binder may be employed in amounts ranging from about 5 to about 15 percent by weight, based upon the total composition of the printing paste. This low concentration of binder, along with the ultra fine pigments employed, allows for the printed fabrics to achieve a soft hand feel.

One binder suitable for use in the present invention is a proprietary aqueous acrylic dispersion having a very low residual monomer. This binder has very good fastness properties and prints with a pleasant soft hand.

In one embodiment, a cross-linking/softener agent may be added to the printing paste with the ultra fine pigment dyestuffs and binder. One such cross-linker suitable for use in the present invention is a non-ionic emulsifying mixture containing a melamine-formaldehyde resin. This cross-linker/softening agent may be a catalyst to the binder described above. The concentration of the binder can be further reduced when using this cross-linker, it being understood that the less binder used, the softer the hand feel of the fabric. This ingredient is a cross-linker/auxiliary combination for low formaldehyde pigment printing. It also improves the running properties of the print pastes and facilitates cleaning of the screen.

In another embodiment, a thickening agent may be included in the printing paste to thicken the printing paste for printing. Typically, a water-soluble thickener may be used so that it can be washed away during the washing step of the printing process. One particular suitable thickener is an acrylic polymer. This high-polymer, synthetic thickening agent is used for solvent-free and low solvent pigment printing. It allows the preparation of printing pastes that have very good running properties and produce brilliant prints with excellent contour definition. In one embodiment, the thickening agent is employed in amounts ranging from about 0.1 to about 80 weight percent, based upon the total weight composition of the printing paste. This component is also suitable for supplemental thickening of the print pastes and for solvent-free pigment discharge and resist printing under reactive dyes.

In yet another embodiment, the printing paste may include silicon to improve the brilliance of the color shade with a non-tacky hand feel. One suitable silicon is actually a proprietary blend of silicones that acts as a hydrophobic softener. This proprietary blend of silicones can be applied to all kinds of fibers and yarns, including cotton, polyester, wool/linen, acrylic, etc., in the production of the printing pastes for the fabrics. It is used to enhance the penetration of the pigment into the fabrics and minimizes the usage of the pigment to achieve the required shade, thereby again improving the softness of the hand feel.

In most embodiments, the binder, softeners, pigment colorants are only printed where the substrate fabric requires printing—as defined by the artwork. This is distinct from normal printing where the softeners are added to the entirety of the fabric surface. Benefits of this include using minimal but sufficient printing materials and keeping the unprinted areas free from other contaminants when their presence are not necessary.

Once the printing paste is prepared as described above, the printing process proceeds with the printing paste being administered by printing onto the fabric, such as by silk screening, to form a print on the fabric. After printing, at least that portion of the fabric having the print is cured or heated to a temperature of at least 150° C., so as to cure the printing paste and, specifically, the binder, and achieve effective fixation of the pigment to the fabric. In one embodiment, this heating process may be conducted by steaming the printed fabric. In other embodiments, the printed fabric may be superheated using various apparatuses known in the art.

Next, the printed fabric may be washed to remove the thickening agent of the printing paste and to apply one or more additives, such as a softening agent, to the printed fabric. In one embodiment, the step of washing is conducted at least twice. More particularly, the printed fabric is treated with a micro-emulsion that increases the soft hand feel as well as the abrasion resistance of the fabric. In at least one washing step, the washing process removes the thickening agent so that the softening agent and other additives can better penetrate into the fabric. In this way, less binder is used, resulting in softer hand feel and maintaining color fastness. The tendency of creasing is also reduced.

Any of a number of additives may be used in the washing process. In one embodiment, a wetting agent may be included in the washing process to improve the hydrophilic property of the fabric during washing. One example of a suitable wetting agent would be an alkylphenol ethoxylate compound. This wetting agent and detergent for the textile industry is water free, non-ionic, and a very good emulsifier. It provides scouring action for oils and fatty substances. It also activates enzymes for degradizing the starch in desizing liquors. It also prevents the build-up of deposits on the pad rollers in resin finishing liquors.

In another embodiment, a softening agent can be included as an additive. A softener would help to expand the fibers to improve the hand feel of the fabric during washing. One example of a suitable softener would be a non-ionic softener for resin finish and conventional finish of the fabrics. It has softening and stabilizing effects in the peroxide bleach, and avoids the formation of running crease during printing or dyeing.

After washing, the printed fabrics undergo finishing setting wherein the softness and hand feel of the fabrics are further improved through the use of a specially designed finishing process. The finishing process includes that addition of finishing agents to the fabric to increase the bursting strength of the fabrics, to increase the wet crocking fastness of the fabrics and to maintain good shrinkage of the fabrics. The final fabrics will achieve a very soft hand feel that is very comparable to reactive printings.

In the finishing process, finishing agents are used. Any of a number of types of finishing agents may be used with the printed fabrics. For instance, in one embodiment, the finishing agents may include a non-ionic finishing agent designed to provide improved sewing properties of knitted goods. In another embodiment, the finishing agent may include a modified polyurethane reactant that is effective for wash and wear finishing of cellulose-based fibers and blends of these fibers with synthetic fibers. This finishing agent is particularly suitable for use in permanent press applications. It is also capable of self-crosslinking with the hydroxyl groups of the cellulose in the curing process. Fabrics treated with this finishing agent exhibit good shrinkage and non-formaldehyde properties. It may also improve the wet crocking fastness, anti-pilling and embossing effects of the fabrics as well.

In yet another embodiment, the finishing agent may include a silicon. One example of a suitable silicon for use as the finishing agent of the fabrics of the present invention would include various proprietary concentrated silicons. At least one of these finishing agents comprises mainly an amino-modified polydimethyl siloxane micro-emulsion for treating various kinds of fabrics to impart pliability, smoothness, crease resistance, and soft, velvet-like hand feel. It also provides good drape characteristics, lowers yellowing, increases fabric elasticity and crease recovery, and increases fabric tensile and tear strength.

Thus, it should be evident that the pigment printing process of the present invention provides a pigment printed fabric that has a soft hand feel that is softer than the hand feel of a comparable pigment printed fabric using a similar color pigment paste but having pigment particles or dyestuffs that have at least a majority of the pigment particles that are larger than about 1 micron in diameter. To confirm this fact, the present invention was tested using the KES-FB system. Specifically, sixteen (16) measurements of various physical properties were taken of a 65% polyester/35% cotton blend fabric that had been pigment printed using a color printing paste having a majority of pigment particles of a size at least greater than 1 micron (Control Fabric). This Control Fabric was tested against the fabric of the present invention wherein a 65% polylester/35% cotton blend fabric was pigment printed using the pigment paste of the present invention having most of the pigment particles of a size no larger than 1 micron, and a majority of the pigment particles within the range of from about 100 nanometers to about 400 nanometers (Tested Fabric). The results of the tested physical properties of these two printed fabrics are set forth in TABLE I below.

TABLE I
Tested Physical Properties of Pigment Printed 65/35 Polyester/Cotton
Fabric Using KES-FB System

| | Control Fabric | Tested Fabric |
|---|---|---|
| | (Pigments > 1 μm) | (Pigments < 1 μm) |
| Surface: | | |
| MIU | 0.347 | 0.286 |
| MMD | 0.0308 | 0.0233 |
| SMD | 4.86 | 4.21 |
| Bending: | | |
| B | 0.0470 | 0.0254 |
| 2HB | 0.0269 | 0.0178 |
| Shear: | | |
| G | 1.38 | 0.99 |
| 2HG | 4.11 | 2.21 |
| 2HG5 | 4.88 | 2.40 |
| Tensile: | | |
| LT | 0.799 | 0.760 |
| WT | 15.18 | 19.10 |
| RT | 35.86 | 41.46 |
| EMT | 14.94 | 19.85 |
| Compression: | | |
| LC | 0.416 | 0.352 |
| WC | 0.407 | 0.370 |
| RC | 42.26 | 49.73 |
| EMC = (TO − TM/TO) | 38.67 | 41.75 |
| Thickness: | | |
| TO | 1.011 | 1.006 |
| TM | 0.620 | 0.586 |
| Total Hand Value | 1.50 | 1.66 |
| Knitted - Summer | | |

From the Total Hand Value, it is shown that the tested pigment printed fabric of the present invention has a slightly better hand feeling compared with that of the Control pigment printed fabric. However, due to the fact that some primary hand values are out of range, the Total Hand Values may not be completely reliable. Instead, a comparison of the individual physical properties and characteristics provide a more accurate view concerning softness, stiffness, and smoothness.

As shown in TABLE I, the pigment printed fabric of the present invention (i.e., the Tested Fabric) has lower friction (MIU) and surface contour (SMD) than the Control Fabric. MIU and SMD are two important parameters influencing the fabric smoothness. Further, the Tested Fabric has lower rigidities in both bending (B) and shearing (G) than the Control Fabric, which properties are important parameters in hand feeling for flexing the fabric in multi-directional deformation. When the values in the hysteresis (2HB, 2HG, 2HG5) for these two rigidities are included, the Tested Fabric shows that it has better resilience than the Control Fabric. Hence, the Tested Fabric may be concluded to be less stiff and provide better recovery than the Control Fabric. Also, for all compressional properties, including the force required to compress (LC, WC), resilience to original thickness after compression (RC) and amount of fabric thickness being compressed (EMC), the Tested Fabric shows better performance which are the important parameters in softness (compression). In tensile (i.e. pulling) properties, it shows less initial modulus (LT) to extend the fabric with higher extensibility (EMT). From the above analysis of individual characteristics, it can be concluded that the Tested Fabric of the present invention has better hand feel in smoothness (i.e., more smooth), stiffness (i.e., less stiff), and softness (compression) compared to the Control Fabric.

Furthermore, it should be evident that the pigment printing process of the present invention provides a pigment printed fabric that has a hand feel that is at least comparable to that of reactive printed fabrics. Again, to evidence this, fabrics of the present invention and reactive printed fabrics were tested using the KES-FB system. Specifically, samples of a cotton interlock fabric and of a cotton/spandex blended fabric that had been pigment printed upon using the techniques of the present invention were compared with samples of a cotton interlock fabric and of a cotton/spandex blended fabric that had been printed upon using reactive printing techniques. In all, sixteen (16) measurements of various physical properties were taken of each sample of the cotton interlock fabrics and the cotton/spandex blended fabrics that had been reactive printed using a reactive printing process or pigment printed using the pigment paste of the present invention. The test data below provides the mean averages for the tested samples, as the parameters were tested in both the wale and course directions. For comparison purposes, the Reactive Fabric-Cotton was tested against and compared to the Tested Fabric-Cotton of the present invention, while the Reactive Fabric Cotton/Spandex was tested against and compared to the Tested Fabric Cotton/Spandex of the present invention. The Tested Fabrics of the present invention were pigment printed using the pigment paste of the present invention having most of the pigment particles of a size no larger than 1 micron, and a majority of the pigment particles within the range of from about 100 nanometers to about 400 nanometers. A comparison of the results of the tested physical properties of the Reactive Fabrics and the Tested Fabrics of the present invention are set forth in TABLE II below.

TABLE II
Tested Physical Properties of Pigment Printed Cotton and Cotton/Spandex Fabrics versus
Reactive Printed Cotton and Cotton/Spandex Fabrics Using KES-FB System

| | Invention | Invention Fabric | Reactive | Reactive Fabric |
|---|---|---|---|---|
| | Fabric-Cotton | Cotton/Spandex | Fabric-Cotton | Cotton/Spandex |
| Surface: | | | | |
| MIU | 0.343 | 0.411 | 0.362 | 0.420 |
| MMD | 0.0206 | 0.0215 | 0.0170 | 0.0190 |
| SMD | 3.63 | 3.72 | 3.51 | 3.67 |
| Bending: | | | | |
| B | 0.0498 | 0.0353 | 0.0598 | 0.0227 |
| 2HB | 0.0477 | 0.0343 | 0.0603 | 0.0361 |
| Shear: | | | | |
| G | 0.82 | 0.64 | 0.75 | 0.59 |
| 2HG | 2.94 | 1.49 | 2.79 | 1.51 |
| 2HG5 | 3.23 | 1.54 | 2.98 | 1.53 |
| Tensile: | | | | |
| LT | 0.713 | 0.685 | 0.703 | 0.708 |
| WT | 35.49 | 78.59 | 43.38 | 91.10 |
| RT | 26.23 | 28.91 | 21.50 | 27.04 |
| EMT | 39.12 | 91.44 | 47.86 | 102.61 |
| Compression: | | | | |
| LC | 0.335 | 0.319 | 0.337 | 0.355 |
| WC | 0.276 | 0.392 | 0.440 | 0.441 |
| RC | 37.73 | 34.28 | 38.40 | 35.22 |
| EMC = (TO − TM/ | 27.62 | 37.85 | 36.07 | 38.02 |
| TO) | | | | |
| Thickness: | | | | |
| TO | 1.196 | 1300 | 1.452 | 1.309 |
| TM | 0.866 | 0.828 | 0.928 | 0.811 |
| Total Hand | 1.27 | 1.66 | 1.62 | 1.84 |
| Value - Knitted | | | | |
| Summer | | | | |

From the Total Hand Value, it is shown that the Reactive Fabrics have only a slightly better hand feeling compared with that of the Tested Fabrics of the present invention. However, due to the fact that some primary hand values are out of range, the Total Hand Values may not be completely reliable. Instead, a comparison of the individual physical properties and characteristics provide a more accurate view concerning softness, stiffness, and smoothness.

As shown in TABLE II, for both the cotton fabric and the cotton/spandex blended fabric, the pigment printed fabric of the present invention (i.e., the Tested Fabrics) has lower friction (MIU) and higher surface contour (SMD) than the reactive printed fabric (i.e., the Reactive Fabrics). MIU and SMD are two important parameters influencing the fabric smoothness. The lower MIU and lower SMD provide for a more smooth fabric. In these parameters of friction (MIU) and surface contour (SMD) and their deviations, there is no significant difference between the pigment printed fabrics of the present invention and the reactive printed fabrics.

Bending Rigidity (B) and Shear Rigidity (G) are two important parameters in hand feeling for flexing the fabric in multi-directional deformation. As shown in TABLE II, the Tested Fabric had statistically substantially the same rigidities in both bending (B) and shearing (G) as did the Reactive Fabrics. When the values in the hysteresis (2HB, 2HG, 2HG5) for these two rigidities are included, the Tested Fabrics had the best performance in the bending properties, but not significantly different in the shear properties when compared with the Reactive Fabrics.

In tensile (i.e. pulling) properties, TABLE II shows that the Tested Fabrics are substantially equal to the Reactive Fabrics with respect to initial modulus (LT). The Tested Fabrics have lower extensibility (EMT), but have better resilience (RT) than the Reactive Fabrics. However, for all compressional properties, including the force required to compress (LC, WC), resilience to original thickness after compression (RC) and amount of fabric thickness being compressed (EMC), the Reactive Fabrics did show better performance, which are the important parameters in softness (compression). From the above analysis of individual characteristics, it can be concluded that the Tested Fabrics of the present invention have better hand feel in stiffness (i.e., less stiff), essentially the same smoothness (i.e., equally smooth), but have less softness due to compression compared to the Reactive Fabrics. Given this analysis, the hand feel of the pigment printed fabrics are believed to be comparable to those of reactive printed fabrics.

Furthermore, it should also be evident that the pigment printing process as a whole is more environmentally friendly than reactive printing, having fewer steps, leading to less energy consumption and providing less pollution. In addition, it should be further evident that the process provides pigment printed fabrics that are highly satisfactory in performance with respect to color fastness and resistance to bleaching. That is, the printed fabrics of the present invention are believed to be able to withstand chlorine bleaching. Moreover, the method of pigment printing provided can be brushed, sanded and washed without losing the effects of softness of hand or fastness of color.

Thus, it will be appreciated that several alternative embodiments and structural equivalents of the fabrics are contemplated, it being understood that the printing method of the present invention may be applicable to natural or synthetic or blended fabrics. The present invention is particularly desirable for polyester/cotton blended fabrics with or without the addition of elastic fibers such as spandex. The use of such fabrics with reactive printing is not possible. Still further, bright color printing may be achieved, which is in contrast to reactive printing wherein the resultant reactive printed prints are typically dull in color.

In light of the foregoing, it should thus be evident that the present invention substantially improves the art of pigment printed fabrics, and provides particular advantages for pigment printing processes. While a full and complete description of the invention has been set forth in accordance with the dictates of the patent statutes, it should be understood that modifications can be resorted to without departing from the spirit hereof or the scope of the appended claims.

What is claimed is:

1. A method for pigment printing onto a fabric, the method comprising:
preparing a color pigment paste, the paste including pigments of a desired color having a majority of pigment particles of a size no larger than about 1 micron in diameter, a binder and a thickening agent;
printing the prepared color pigment paste onto the fabric;
heating the printed fabric to a temperature of at least 150° C.;
washing the fabric at least once to remove the thickening agent and to incorporate a softening agent into the fabric, thereby providing the fabric with a softer hand feel than the fabric had before the washing; and
finishing setting the fabric.

2. The method of claim 1, wherein the color pigment paste further includes a cross-linking agent.

3. The method of claim 1, wherein the pigments are selected from the group consisting of carbon pigments, iron oxide pigments, chromium pigments, copper pigments and organic pigments.

4. The method of claim 1, wherein substantially all of the pigment particles have a size no larger than about 1 micron in diameter.

5. The method of claim 1, wherein the step of preparing the color pigment paste includes grinding the pigment particles such that a majority of the particles are of a size no larger than 1 micron, and mixing the color pigment paste, binders and thickeners through high speed stirring into a highly homogenous emulsion.

6. The method of claim 1, wherein the step of printing includes silk screen printing the color pigment paste onto the fabric.

7. The method of claim 1, wherein the step of heating includes the step of steaming the printed fabric.

8. A fabric having a print that has been pigment printed onto the fabric using a color pigment paste comprising:
pigment particles of a desired color;
a binder; and
a thickening agent, wherein the majority of said pigment particles have a size that is no larger than about 1 micron in diameter, and wherein the fabric that has been printed upon has a hand feel that is softer, smoother and less stiff than a hand feel of a comparable fabric having a print that has been pigment printed upon using a color pigment paste including pigment particles, but wherein a majority of the pigment particles of the color pigment paste used for the print on the comparable fabric are larger than about 1 micron in diameter.

9. The fabric of claim 8, wherein the color pigment paste further includes a cross-linking agent.

10. The fabric of claim 8, wherein the color pigment paste further includes silicon.

11. The fabric of claim 8, wherein the pigment particles are selected from the group consisting of carbon pigments, iron oxide pigments, chromium pigments, copper pigments and organic pigments.

12. The fabric of claim 8, wherein substantially all of the pigment particles have a size no larger than about 1 micron in diameter.

13. The fabric of claim 12, wherein most of the pigment particles have a size ranging from about 100 nanometers to about to about 1 micron in diameter.

14. The fabric of claim 12, wherein most of the pigment particles have a size ranging from about 100 nanometers to about to about 400 nanometers in diameter.

15. A pigment printed fabric having a soft hand feel comparable to a reactive printed fabric.
